(19) United States
(12) Patent Application Publication
(10) Pub. No.: US 2020/0392419 A1
(43) Pub. Date: Dec. 17, 2020

(54) COMPOSITION OF ESTERIFIED LIGNIN IN HYDROCARBON OIL

(71) Applicant: REN FUEL K2B AB, Stockholm (SE)

(72) Inventors: Joakim LÖFSTEDT, Uppsala (SE); Christian DAHLSTRAND, Uppsala (SE); Alexander OREBOM, Uppsala (SE); Joseph SAMEC, Stockholm (SE)

(21) Appl. No.: 16/970,945

(22) PCT Filed: Feb. 25, 2019
(86) PCT No.: PCT/SE2019/050167

§ 371 Date: Aug. 18, 2020

(30) Foreign Application Priority Data
Feb. 23, 2018 (SE) 1850208-8

(51) Int. Cl. C10L 1/02; C08H 7/00; C08L 97/00; C08L 91/00

(52) U.S. Cl. CPC C10L 1/02; C08H 6/00; C10L 2200/0469; C08L 91/00; C08L 97/005

(57) ABSTRACT

The present invention relates to a composition comprising hydrocarbon oil and substituted lignin, wherein the lignin has been substituted by esterification and acetylation of the hydroxyl groups, wherein the hydroxyl groups are esterified with a C14 or longer fatty acid at a degree of substitution of at least 20%, wherein the hydroxyl groups are acetylated at a degree of substitution of at least 20% and wherein at least 90% of the hydroxyl groups of the lignin is substituted by esterification and acetylation. The composition is essentially free from free fatty acid.

### FIELD OF THE INVENTION

The present invention relates to a composition of substituted lignin in a hydrocarbon oil suitable for preparing fuel and fuel additives in a refinery process. The lignin has been substituted with fatty acid via ester linkages but the composition is essentially free from free fatty acids.

### BACKGROUND

There is an increasing interest in using biomass as a source for fuel production. Biomass includes, but is not limited to, plant parts, fruits, vegetables, processing waste, wood chips, chaff, grain, grasses, corn, corn husks, weeds, aquatic plants, hay, paper, paper products, recycled paper and paper products, lignocellulosic material, lignin and any cellulose containing biological material or material of biological origin.

An important component of biomass is the lignin present in the solid portions of the biomass. Lignin comprises chains of aromatic and oxygenate constituents forming larger molecules that are not easily treated. A major reason for difficulty in treating the lignin is the inability to disperse the lignin for contact with catalysts that can break the lignin down.

Lignin is one of the most abundant natural polymers on earth. One common way of preparing lignin is by separation from wood during pulping processes. Only a small amount (1-2%) is utilized in specialty products whereas the rest primary serves as fuel. Even if burning lignin is a valuable way to reduce usage of fossil fuel, lignin has significant potential as raw material for the sustainable production of chemicals and liquid fuels.

Various lignins differ structurally depending on raw material source and subsequent processing, but one common feature is a backbone consisting of various substituted phenyl propane units that are bound to each other via aryl ether or carbon-carbon linkages. They are typically substituted with methoxyl groups and the phenolic and aliphatic hydroxyl groups provide sites for e.g. further functionalization. Lignin is known to have a low ability to sorb water compared to for example the hydrophilic cellulose.

Today lignin may be used as a component in for example pellet fuel as a binder but it may also be used as an energy source due to its high energy content. Lignin has higher energy content than cellulose or hemicelluloses and one gram of lignin has on average 22.7 KJ, which is 30% more than the energy content of cellulosic carbohydrate. The energy content of lignin is similar to that of coal. Today, due to its fuel value lignin that has been removed using the kraft process, sulphate process, in a pulp or paper mill, is usually burned in order to provide energy to run the production process and to recover the chemicals from the cooking liquor.

There are several ways of separating lignin from black or red liquor obtained after separating the cellulose fibres in the kraft or sulphite process respectively, during the production processes. One of the most common strategies is membrane or ultra-filtration. Lignoboost® is a separation process developed by Innventia AB and the process has been shown to increase the lignin yield using less sulphuric acid. In the Lignoboost® process, black liquor from the production processes is taken and the lignin is precipitated through the addition and reaction with acid, usually carbon dioxide (CO₂), and the lignin is then filtered off. The lignin filter cake is then re-dispersed and acidified, usually using sulphuric acid, and the obtained slurry is then filtered and washed using displacement washing. The lignin is usually then dried and pulverized in order to make it suitable for lime kiln burners or before pelletizing it into pellet fuel.

Biofuel, such as biogasoline and biodiesel, is a fuel in which the energy is mainly derived from biomass material or gases such as wood, corn, sugarcane, animal fat, vegetable oils and so on. However the biofuel industries are struggling with issues like food vs fuel debate, efficiency and the general supply of raw material. At the same time the pulp or paper making industries produces huge amounts of lignin which is often, as described above, only burned in the mill. Two common strategies for exploring biomass as a fuel or fuel component are to use pyrolysis oils or hydrogenated lignin.

In order to make lignin more useful one has to solve the problem with the low solubility of lignin in organic solvents. One drawback of using lignin as a source for fuel production is the issue of providing lignin in a form suitable for hydrotreaters or crackers. The problem is that lignin is not soluble in oils or fatty acids which is, if not necessary, highly wanted.

Prior art provides various strategies for degrading lignin into small units or molecules in order to prepare lignin derivatives that may be processed. These strategies include hydrogenation, dexoygenation and acid catalyst hydrolysis. WO2011003029 relates to a method for catalytic cleavage of carbon-carbon bonds and carbon-oxygen bonds in lignin. US20130025191 relates to a depolymerisation and deoxygenation method where lignin is treated with hydrogen together with a catalyst in an aromatic containing solvent. All these strategies relates to methods where the degradation is performed prior to eventual mixing in fatty acids or oils. WO2008/157164 discloses an alternative strategy where a first dispersion agent is used to form a biomass suspension to obtain a better contact with the catalyst. These strategies usually also requires isolation of the degradation products in order to separate them from unwanted reagents such as solvents or catalysts.

In WO2015/094099 the present applicant presents a strategy where lignin is modified with an alkyl group via an ester linkage in order to make the lignin more soluble in oils or fatty acids. The esterification is done in excess of fatty acids leaving a composition with high amount of free acids. In WO2014/116173 the present applicant teaches a composition of lignin or lignin derivatives in a carrier liquid and a solvent where the lignin has a molecular weight of not more than 5,000 g/mol.

WO2014/193289 teaches a method where black liquor is membrane filtrated followed by a depolymerization step where after the depolymerized lignin is separated. The depolymerization may be done by treating the membrane filtrated lignin at high temperature and pressure.

WO2012/094099 discloses a method of esterifying lignin and dissolving the lignin in carrier liquids. In order to lower the number of acid groups and in order to remove the free fatty acids remaining after the esterification several purification steps are necessary and even then the composition would still contain large contents of acids.

Conventional refineries are sensitive to acidity and acidic compounds since the equipment is not made of acid resistant material, and in combination with the conditions during the refinery process acidic compositions may seriously damage the equipment.

The economic benefits of producing fuels from biomass depend for example on an efficient process for preparing the lignin and on the preparation of the lignin or lignin derivatives so that the fuel production is as efficient as possible. For example the amount of oxygen should be as low as possible and the number of preparation steps should be as few as possible. A high oxygen content requires more hydrogen during the refinery process.

One way of making fuel production of lignin more beneficial would be if lignin may be processed using common oil refinery techniques such catalytic cracking or hydrotreatment. In order to do that the lignin needs to be soluble in refinery media such as hydrocarbon oils.

### SUMMARY OF THE INVENTION

The object of the present invention is to overcome the drawbacks of the prior art and provide a composition comprising substituted lignin in a hydrocarbon oil. The composition is essentially free from any free or non-bonded fatty acid and where the TAN is also very low leaving a composition suitable for refinery processes. One advantage of a composition essentially free from free fatty acid and having a low TAN as the present invention is that the composition may be used in conventional refineries. Many fatty acids for example tall oil fatty acid (TOFA) are a scarcity and by reducing the amount of fatty acid used to prepare the composition the composition becomes less dependent on the availability of such fatty acid. Furthermore by allowing all added fatty acids to bind to the lignin there is no need for any tedious or expensive removal of any free fatty acid. All of this makes the present invention cheaper and more cost efficient both to produce and use.

In a first aspect the present invention relates to a composition comprising hydrocarbon oil and substituted lignin, wherein the lignin has been substituted by esterification and acetylation of the hydroxyl groups, wherein the hydroxyl groups are esterified with a C14 or longer fatty acid at a degree of substitution of at least 20%, wherein the hydroxyl groups are acetylated at a degree of substitution of at least 20% and wherein at least 90% of the hydroxyl groups of the lignin is substituted by esterification and acetylation; and wherein the composition is essentially free from free fatty acid and wherein the TAN of the composition is less than 60 mg KOH/g substituted lignin.

In a second aspect the present invention relates to a method of preparing the composition comprising
a. Providing lignin, a C14 or longer fatty acid, a solvent, a nitrogen containing aromatic heterocycle catalyst, hydrocarbon oil and acetic anhydride;
b. Mixing the fatty acid with an molar excess of acetic anhydride forming a first mixture;
c. Heating the first mixture forming fatty acid anhydride and acetic acid;
d. Removing the formed acetic acid;
e. Mixing the lignin, the fatty acid anhydride, the solvent and the catalyst forming a second mixture;
f. Heating the second mixture forming esterified lignin and free fatty acid;
g. Adding acetic anhydride to the second mixture comprising esterified lignin and free fatty acid forming a third mixture wherein the amount of acetic anhydride is in molar excess to the free fatty acid;
h. Heating the third mixture forming the substituted lignin and acetic acid;
i. Removing the formed acetic acid and optionally any excess of acetic anhydride;
j. Mixing the substituted lignin with the hydrocarbon oil.

In a third aspect the present invention relates to a method of preparing fuel comprising treating the composition according to the present invention in a hydrotreater or a catalytic cracker

In a fourth aspect the present invention relates to a fuel obtained from the method of preparing fuel according to the present invention.

In a fifth aspect the present invention relates to a fuel additive comprising the composition according to the present invention.

### BRIEF DESCRIPTION OF THE FIGURES

FIG. 1, PNMR of a) lignin from Lignoboost® and b) substituted lignin according to the present invention. Acids are seen at 134 ppm.

FIG. 2, HMBC of composition according to the present invention disclosing no free fatty acids.

FIG. 3, HMBC of composition showing some free fatty acids.

FIG. 4, HMBC according to the present invention disclosing no free fatty acids.

FIG. 5, table of ratios of oleic acid and acetic anhydride.

FIG. 6, schematic view of the reaction scheme.

FIG. 7, reaction parameters for preparing substituted lignin. The temperature is for the oil bath.

### DETAILED DESCRIPTION OF THE INVENTION

The present invention relates to a composition for use in a refinery processes for the production of various fuels or chemicals.

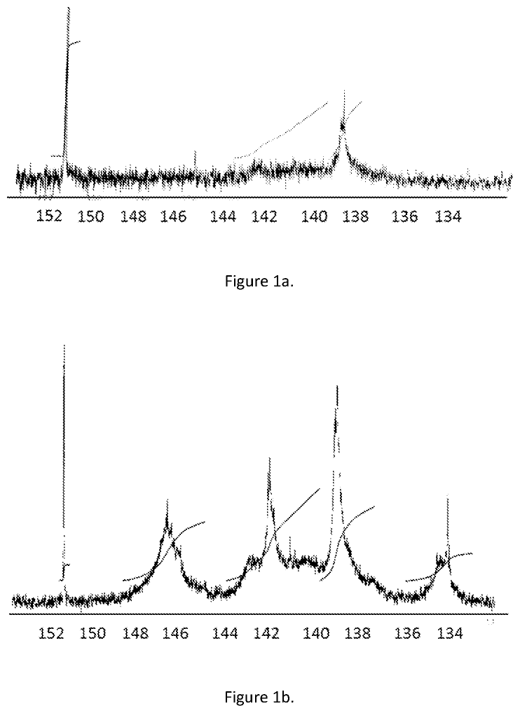

In the present application the term “lignin” means a polymer comprising coumaryl alcohol, coniferyl alcohol and sinapyl alcohol monomers. FIG. 1 discloses a schematic picture of lignin.

In the present application the term “carrier liquid” means an inert hydrocarbon liquid suitable for a hydrotreater or a catalytic cracker (cat cracker) a liquid and may be selected from fatty acids or mixture of fatty acids, esterified fatty acids, triglyceride, rosin acid, crude oil, mineral oil, tall oil, creosote oil, tar oil, bunker fuel and hydrocarbon oils or mixtures thereof.

In the present invention the term “oil” means a nonpolar chemical substance that is a viscous liquid at ambient temperature and is both hydrophobic and lipophilic.

In the present application the terms “red liquor” and “brown liquor” denote the same liquor.

When calculating number of repeating units and equivalents one repeating unit of lignin is assumed to be 180 Da. The number of hydroxyl groups in the lignin is measured and calculated by preparing three stock solutions according to prior art and measured using phosphorus NMR (³¹PNMR), Varian 400 MHz. On average each monomer unit contains between 1 to 1.17 hydroxyl groups.

For a substance to be processed in a refinery such as an oil refinery or bio oil refinery, the substance needs to be in liquid phase. Either the substance is in liquid phase at a given temperature (usually below 80° C.) or the substance is solvated in a liquid. In this patent application, such liquid will be given the term solvent or carrier liquid. The present invention presents a composition and a method of preparing said composition where the composition comprises lignin, where the composition is in liquid phase and may be processed in a refinery such as an oil refinery. The present invention makes it easier or even facilitates production of fuel from lignin through conventional oil refinery processes.

Lignin

In order to obtain lignin biomass may be treated in any suitable way known to a person skilled in the art. The biomass may be treated with pulping processes or organosols processes for example. Biomass includes, but is not limited to wood, fruits, vegetables, processing waste, chaff, grain, grasses, corn, corn husks, weeds, aquatic plants, hay, paper, paper products, recycled paper, shell, brown coal, algae, straw, bark or nut shells, lignocellulosic material, lignin and any cellulose containing biological material or material of biological origin. In one embodiment the biomass is wood, preferably particulate wood such as saw dust or wood chips. The wood may be any kind of wood, hard or soft wood, coniferous tree or broad-leaf tree. A non-limiting list of woods would be pine, birch, spruce, maple, ash, mountain ash, redwood, alder, elm, oak, larch, yew, chestnut, olive, cypress, banyan, sycamore, cherry, apple, pear, hawthorn, magnolia, sequoia, walnut, karri, coolabah and beech.

It is preferred that the biomass contains as much lignin as possible. The Kappa number estimates the amount of chemicals required during bleaching of wood pulp in order to obtain a pulp with a given degree of whiteness. Since the amount of bleach needed is related to the lignin content of the pulp, the Kappa number can be used to monitor the effectiveness of the lignin-extraction phase of the pulping process. It is approximately proportional to the residual lignin content of the pulp.

K≈c*l

K: Kappa number; c: constant 6.57 (dependent on process and wood); l: lignin content in percent. The Kappa number is determined by ISO 302:2004. The kappa number may be 20 or higher, or 40 or higher, or 60 or higher. In one embodiment the kappa number is 10-100.

The biomass material may be a mixture of biomass materials and in one embodiment the biomass material is black or red liquor, or materials obtained from black or red liquor. Black and red liquor contains cellulose, hemi cellulose and lignin and derivatives thereof. The composition according to the present invention may comprise black or red liquor, or lignin obtained from black or red liquor.

Black liquor comprises four main groups of organic substances, around 30-45 weight % ligneous material, 25-35 weight % saccharine acids, about 10 weight % formic and acetic acid, 3-5 weight % extractives, about 1 weight % methanol, and many inorganic elements and sulphur. The exact composition of the liquor varies and depends on the cooking conditions in the production process and the feedstock. Red liquor comprises the ions from the sulfite process (calcium, sodium, magnesium or ammonium), sulfonated lignin, hemicellulose and low molecular resins.

The lignin according to the present invention may be Kraft lignin, sulfonated lignin, Lignoboost® lignin, precipitated lignin, filtrated lignin, acetosolv lignin or organosolv lignin. In one embodiment the lignin is Kraft lignin, acetosolv lignin or organosolv lignin. In another embodiment the lignin is Kraft lignin. In another embodiment the lignin is organosolv lignin. In another embodiment the lignin obtained as residual material from ethanol production. In one embodiment the lignin preferably Kraft lignin is acid precipitated lignin such as Lignoboost which has been solvent extracted. The lignin may be in particulate form with a particle size of 5 mm or less, or 1 mm or less.

Native lignin or Kraft lignin is not soluble in most organic solvents or oils. Instead prior art have presented various techniques to depolymerize and covert the depolymerized lignin into components soluble in the wanted media.

Lignin is not soluble in most organic solvents or oils. Instead prior art have presented various techniques to depolymerize and covert the depolymerized lignin into components soluble in the wanted media.

The number average molecular weight (mass) (Mₙ) of the lignin may be 30,000 g/mol or less, such as not more than 20,000 g/mol, or not more than 10,000 g/mol, or not more than 6,000 g/mol, or not more than 4,000 g/mol, or not more than 2,000 g/mol, or not more than 1,000 g/mol, but preferably higher than 800 g/mol, or more preferably higher than 950 g/mol. In one preferred embodiment the number average molecular weight of the lignin is between 1000 and 5,000 g/mol, or between 1200 and 3,000 g/mol.

The substituted lignin may have a number average molecular weight (Mₙ) of 800 g/mol or more, or 1,000 g/mol or more, or 2,000 g/mol or more, or 3,000 g/mol or more, or 4,000 g/mol or more but less than 10,000 g/mol, or less than 7,000 g/mol. In one preferred embodiment the number average molecular weight (Mₙ) is 1,000 to 6,000 g/mol, or 1,300 g/mol to 3,000 g/mol.

The Composition

The composition according to the present invention comprises hydrocarbon oil which may act as a carrier liquid especially when the composition is used in a refinary process for example for preparing fuels and chemicals. The lignin in the composition has been substituted by esterification and acetylation of the hydroxyl groups. Some of the hydroxyl groups are esterified with a C14 or longer fatty acid and some of the hydroxyl groups are acetylated.

The purpose of the carrier liquid is to carry the wanted substrate or solution into the reactor without reacting or in any other way affecting the substrate or solution. Therefore, in one embodiment of the present application the carrier liquid is an inert hydrocarbon with a high boiling point, preferably at least 150° C.

The carrier liquid should preferably be suitable for a hydrotreater or a catalytic cracker (cat cracker), preferably a liquid suitable for both hydrotreater and catalytic cracker. Hydrotreating and catalytic cracking are common steps in the oil refinery process where the sulfur, oxygen and nitrogen contents of the oil is reduced and where high-boiling, high molecular weight hydrocarbons are converted into gasoline, diesel and gases. During hydrotreating the feed is normally exposed to hydrogen gas (20-200 bar) and a hydrotreating catalyst (NiMo, CoMo or other HDS, HDN, HDO catalyst) at elevated temperatures (200-500° C.). The hydrotreatment process results in hydrodesulfurization (HDS), hydrodenitrogenation (HDN), and hydrodeoxygenation (HDO) where the sulphurs, nitrogens and oxygens primarily are removed as hydrogensulfide, ammonia, and water. Hydrotreatment also results in the saturation of olefins. Catalytic cracking is a category of the broader refinery process of cracking. During cracking, large molecules are split into smaller molecules under the influence of heat, catalyst, and/or solvent. There are several sub-categories of cracking which includes thermal cracking, steam cracking, fluid catalyst cracking and hydrocracking. During thermal cracking the feed is exposed to high temperatures and mainly results in homolytic bond cleavage to produce smaller unsaturated molecules. Steam cracking is a version of thermal cracking where the feed is diluted with steam before being exposed to the high temperature at which cracking occurs. In a fluidized catalytic cracker (FCC) or “cat cracker” the preheated feed is mixed with a hot catalyst and is allowed to react at elevated temperature. The main purpose of the FCC unit is to produce gasoline range hydrocarbons from different types of heavy feeds. During hydrocracking the hydrocarbons are cracked in the presence of hydrogen. Hydrocracking also facilitates the saturation of aromatics and olefins.

The hydrocarbon oil needs to be in liquid phase below 80° C. and preferably have boiling points of 177-371° C. These hydrocarbon oils include different types of gas oils, hydrotreated gas oils, and likewise such as light cycle oil (LCO), light gas oil (LGO), Full Range Straight Run Middle Distillates, Hydrotreated, Middle Distillate, Light Catalytic Cracked Distillate, distillates Naphtha full-range straight-run, hydrodesulfurized full-range, solvent-dewaxed straight-range, straight-run middle sulfenylated, Naphtha clay-treated full-range straight run, Distillates full-range atm, Distillates hydrotreated full-range, Distillates, straight-run light, Distillates heavy straight-run, Distillates (oil sand), straight-run middle-run, Naphtha. (shale oil), hydrocracked, full-range straight run (example of but not restricted to CAS nr: 68476-30-2, 68814-87-9, 74742-46-7, 64741-59-9, 64741-44-2, 64741-42-0, 101316-57-8, 101316-58-9, 91722-55-3, 91995-58-3, 68527-21-9, 128683-26-1, 91995-46-9, 68410-05-9, 68915-96-8, 128683-27-2, 19545949-9). In one embodiment the hydrocarbon oil is a mixture of gas oil such as LGO and hydrotreated gas oil.

The composition according to the present invention may comprise 1-99 weight % of hydrocarbon oil. In one embodiment comprises 20 weight % or more, or 40 weight % or more, or 60 weight % or more, or 80 weight % or more of hydrocarbon oil. In one embodiment the amount of hydrocarbon oil is 60-90 weight % such as 65-85 weight %.

The composition may comprise an organic solvent, or a mixture of organic solvents. The solvent may be a residue from the preparation or may be added to increase the solubility. In one embodiment the organic solvent is pyridine or 4-methyl pyridine. In another embodiment the solvent is an aromatic solvent such as benzene, toluene or xylene. In one embodiment the amount of organic solvent is 20 weight % or less, or 10 weight % or less, or 5 weight % or less, or 2 weight % or less, or 1 weight % or less, or 0.5 weight % or less of the total weight of the composition.

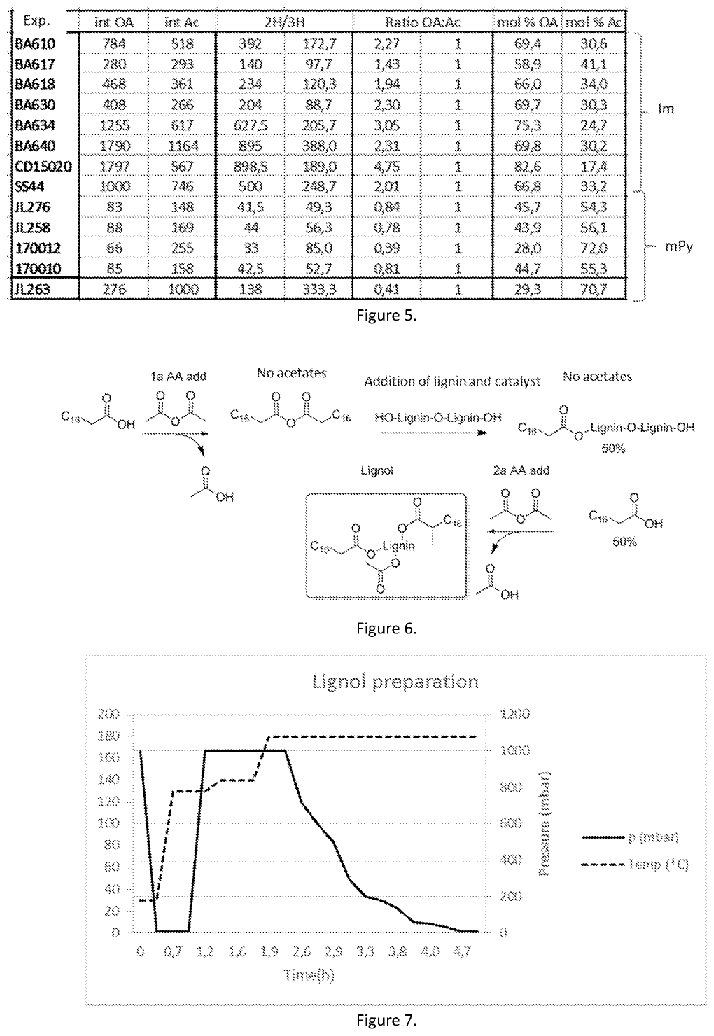

The hydroxyl groups of lignin may be divided into aliphatic hydroxyls (ROH), condensed phenol (PhOH), phenol and acids. The degree of substitution, i.e. the degree of hydroxyl groups that has been converted into ester or acetyl groups, may be from 10% to 100%, for example 20% or more, 30% or more, or 40% or more, or 60% or more, or 80% or more, or 90% or more, or 95% or more, or 99% or more, or 100%. It is also possible to have part of the lignin, or the hydroxyl groups on the lignin, being substituted with one type of ester group (for example C16 ester groups) and another part substituted with another type of ester group (for example C18 ester groups). The ratio between how many of the hydroxyl groups have been esterified with fatty acids and how many have been acetylated may be varied depending on the properties wanted for example. In a preferred embodiment the hydroxyl groups are esterified with a C14 or longer fatty acid at a degree of substitution of at least 30%, more preferably at 35%, more preferably at least 45%, more preferably at least 55% but preferably less than 90%, more preferably less than 80%. The amount of hydroxyl groups that has been acetylated is preferably at least 10%, more preferably at least 20%, more preferably at least 30%, more preferably at least 40% but preferably less than 70%, more preferably less than 60% In one preferred embodiment 25-45% of the hydroxyl groups are substituted with acetyl groups and 55-75% of the hydroxyl groups may be esterified with a fatty acid, preferably C16 or longer fatty acids groups. If the use of less fatty acid is wanted 55-75% of the hydroxyl groups may be acetylated and 25-45%, preferably 30-45%, of the hydroxyl groups may be esterified with a fatty acid, preferably C16 or longer fatty acids. FIG. 5 shows a table of how the amount of oleic acid and acetic anhydride may be varied to obtain different substitutions on the lignin.

Lignin wherein the ester groups are unsaturated is oilier at room temperature while lignin substituted with a saturated ester group is more solid or wax like material. By having the lignin in oil phase there is no need to heat the lignin in order for it to dissolve in the wanted solvent. In order to keep the wax like lignin in solution it needs to be kept at the elevated temperature (for example 70° C.) which makes transportation and stock keeping more costly. However one advantage of the present invention is that the effect of using saturated fatty acids, i.e. that they make the lignin more solid or wax like, becomes less pronounced when the degree of acetylation substitution increases. Therefore in one preferred embodiment the hydroxyl groups are acetylated at a degree of substitution of at least 40% and wherein the hydroxyl groups are esterified with a C14 or longer saturated fatty acid at a degree of substitution of at least 30%, preferably at least 45%.

One advantage of the present invention is that a higher amount of lignin may be dissolved in a carrier liquid such as hydrocarbon oil. The amount of dissolved esterified lignin or lignin derivatives in the composition according to the present invention may be 1 weight % or more, or 2 weight % or more, 4 weight % or more, or 5 weight % or more, or 7 weight % or more, or 10 weight % or more, or 12 weight % or more, or 15 weight % or more, or 20 weight % or more, or 25 weight % or more, or 30 weight % or more, or 40 weight % or more, or 50 weight % or more, or 60 weight % or more, or 70 weight % or more, or 75 weight % or more based on the total weight of the composition.

For many industries, for example the fuel refinery industry processing lignin, the amount of metals should be as low as possible since metals may damage the machinery or disturb the process. The composition according to the present invention may have potassium (K) content of 50 ppm or less, and a sodium (Na) content of 50 ppm or less. In one embodiment the total metal content of the composition is 50 ppm or less, or 30 ppm or less. The sulphur content may be between 2000 and 5000 ppm. The nitrogen content may be 700 ppm or less, or 500 ppm or less, or 300 ppm or less.

An advantage of the present invention is that the composition is essentially free from free fatty acid. In one embodiment the amount of fatty acid is less than 0.5 weight %, or less than 0.1 weight %, or less 0.05 weight %. To detect and measure any presence of free fatty acids HMBC (standard 2D NMR in CDCl3) is used. If there are any free fatty acids a peak at 178 ppm will be seen. TAN measurement may also be used to detect acid groups. TAN measurement is described in detail in the examples.

The composition is preferably also free from any fatty acid anhydrides. In one preferred embodiment the amount of fatty acid anhydride is less than 0.5 weight %, or less than 0.1 weight %, or less 0.05 weight %. The composition is preferably also free from any fatty acid esters such as fatty acid methyl esters. In one preferred embodiment the amount of fatty acid esters is less than 0.5 weight %, or less than 0.1 weight %, or less 0.05 weight %.

By having low fatty acid content the total amount of acids in the composition is reduced.

The total acid number (TAN) of the present composition is less than 60 mg KOH/g substituted lignin, preferably less than 50 mg KOH/g substituted lignin. In one embodiment the TAN is less than 45, or less than 40, or less than 25, or less than 15, or less than 5 mg KOH/g substituted lignin.

Preparation of the Composition

The present inventors found that by substituting lignin by esterification and acetylation of the hydroxyl groups of the lignin the solubility of the lignin increased drastically. The composition according to the present invention may be prepared by first preparing the esterified and acetylated (C2) lignin or lignin derivative and then mixing said esterified lignin with the hydrocarbon oil. The substituted lignin may be isolated from the reaction mixture or the substituted lignin is left in the reaction mixture when mixed with the hydrocarbon oil.

Prior to substitution the provided lignin is preferably solvent extracted and dried in order to purify it from unwanted products such as hemicellulose, salts etc. The extraction may be performed by dissolving the lignin in a first solvent forming a solution or slurry of preferably 10-30 wt % lignin and then mixed with a second solvent that causes the lignin to precipitate. The lignin is then isolated and dried until all the solvent is removed. The drying is preferably done during heating at reduced pressure. The first solvent may be ethyl acetate mixed with methanol or ethanol and the second solvent may be pentane. The solvents used should preferably have a low boiling point in order to facilitate a more efficient and easier drying step.

FIG. 6 discloses a schematic view of the substitution reaction according to the method of the present invention. In general the substitution of the lignin is done by forming a first mixture of a fatty acid (e.g. a C14 or longer fatty acid) and acetic anhydride and letting it react resulting in fatty acid anhydride. The amount of acetic anhydride may be in molar excess to the fatty acid. The fatty acid anhydride is a fatty acid with an anhydride end group or two fatty acids connected via an anhydride. The reaction also produces acids such as acetic acid which is removed together with any excess of the anhydride during or after the reaction. The removal can be done by evaporation or distillation.

In the next step the fatty acid anhydride and the lignin is mixed together with a catalyst and a solvent forming a second mixture. Fatty acid anhydride is added in an amount of 1 equivalence (eq.) or less to the hydroxyl groups of the lignin. Depending on the target degree of substitution of fatty acid and acetylate groups the amount fatty acid anhydride is adjusted accordingly. Since the number of hydroxyl group on the lignin is hard to determine the amount of fatty acid anhydride is preferably less than 1 equivalent more preferably less 0.9 equivalence, more preferably less than 0.8 equivalence. The second mixture is heated forming esterified fatty acid and free fatty acid.

Acetic anhydride is then added forming a third mixture and the mixture is heated resulting in further esterification of the lignin and to acetylation of the lignin, the ratio between esterification and acetylation depends on the amount of fatty acid anhydride used. The amount of acetic anhydride may be in molar excess to the fatty acid in order to minimize the amount of free fatty acids. The formed acetic acid and any excess of acetic anhydride are removed during or after the reaction. The removal can be done by evaporation or distillation at elevated temperature and preferably at reduced pressure. All or essentially all fatty acid used is bonded to the lignin.

The solvent may be any suitable solvent such as pyridine or 4-methyl pyridine. An advantage of using these solvents is that they have a catalytic effect on the substitution reaction as well. The amount of solvent may be 5 to 200 wt % of the weight of the lignin. In one embodiment the amount is 75 to 150 wt % such as around 100 wt %.

Each mixture is preferably heated between 50° C. and 300° C., such as 50° C. or higher, or 80° C. or higher or 100° C. or higher, or 120° C. or higher, or 150° C. or higher, or 180° C. or higher but not higher than 300° C., or 250° C. or lower, or 220° C. or lower, or 200° C. or lower. The heating may be done during refluxing.

The catalyst and solvent and any other unwanted components may be removed afterwards. The mixing can be done by stirring or shaking or in any other suitable way. The esterified lignin may be isolated by precipitation in for example hexane or water or by removal of solvent and catalyst through evaporation or distillation. Preferably using reduced pressure.

The substituted lignin is then mixed with the hydrocarbon oil. The mixing may be done at elevated temperature such as at 120° C. or higher, or 130° C. or higher.

The fatty acid used is a C14 or longer fatty acid and it may be saturated or unsaturated. In one embodiment the fatty acid is a C16 or longer fatty acid. In another embodiment it is a C18 or longer fatty acid. In yet another embodiment the fatty acid is a mixture of C14 or longer fatty acids. In one embodiment the fatty acid is selected from oleic acid, stearic acid and tall oil fatty acids or a combination thereof. An important factor when choosing the fatty acid is the availability and the cost of the fatty acid.

The catalyst for the esterification may be a nitrogen containing aromatic heterocycle such as N-methyl imidazole, 4-methyl pyridine or pyridine or a mixture thereof. Since N-methyl imidazole has a higher boiling point and has a tendency to degrade and thereby result in higher nitrogen content is preferred to replace it with 4-methyl pyridine, which is also cheaper. In one preferred embodiment the catalyst is a mixture of N-methyl imidazole and 4-methyl pyridine. The amount of catalyst is preferably 0.5 equivalents or less in relation to the lignin. In one embodiment the amount is 0.2 equivalents or less, or 0.1 equivalents or less, or 0.07 equivalents or less.

The hydroxyl groups of lignin may be divided into aliphatic hydroxyls (ROH), condensed phenol (PhOH), phenol and acids. The degree of substitution, i.e. the degree of hydroxyl groups that has been converted into ester or acetyl groups, is preferably 10% to 100%, preferably for example 20% or more, 30% or more, or 40% or more, or 60% or more, or 80% or more, or 90% or more, or 95% or more, or 99% or more, or 100%. It is also possible to have part of the lignin, or the hydroxyl groups on the lignin, being substituted with one type of ester group (for example C16 ester groups) and another part substituted with another type of ester group (for example C18 ester groups). Longer fatty acid ester groups, i.e. fatty acids with longer carbon chains, are preferred since it increases the solubility of the substituted lignin. The ratio between how many of the hydroxyl groups have been esterified with fatty acids and how many have been acetylated may be varied depending on the properties wanted for example. In a preferred embodiment the hydroxyl groups are esterified with a C14 or longer fatty acid at a degree of substitution of at least 30%, more preferably at 35%, more preferably at least 45%. In one preferred embodiment 25-45% of the hydroxyl groups are substituted with acetyl groups and 55-75% of the hydroxyl groups may be esterified with a fatty acid, preferably C16 or longer fatty acids groups. If less fatty acid is wanted 55-75% of the hydroxyl groups may be acetylated and 25-45% of the hydroxyl groups may be esterified with a fatty acid, preferably C16 or longer fatty acids. FIG. 5 shows a table of how the amount of oleic acid and acetic anhydride may be varied to obtain different substitutions on the lignin.

Lignin wherein the ester groups are unsaturated is oilier at room temperature while lignin substituted with a saturated ester group is more solid or wax like material. By having the lignin in oil phase there is no need to heat the lignin in order for it to dissolve in the wanted solvent. In order to keep the wax like lignin in solution it needs to be kept at the elevated temperature (for example 70° C.) which makes transportation and stock keeping more costly.

One advantage of the present invention is that a higher amount of lignin may be dissolved in a carrier liquid. The amount of esterified lignin or lignin derivatives in the composition according to the present invention may be 1 weight % or more, or 2 weight % or more, 4 weight % or more, or 5 weight % or more, or 7 weight % or more, or 10 weight % or more, or 12 weight % or more, or 15 weight % or more, or 20 weight % or more, or 25 weight % or more, or 30 weight % or more, or 40 weight % or more, or 50 weight % or more, or 60 weight % or more, or 70 weight % or more, or 75 weight % or more based on the total weight of the composition.

Another advantage of the present invention is that any acetic anhydride that is removed may be reused or recycled. A further advantage is that the present method provides a way of tailoring the degree of substitution.

### EXAMPLES

### Example 1

Stearic acid (6 mg, 0.02 mmol) and acetic anhydride (4 ml, 0.04 mmol) was mixed and heated at 120° C. for 3 h. Acetic acid and any excess of acetic anhydride were distilled off (1 h). Lignoboost® lignin (solvent extracted according to Example 9, 10 mg, 0.06 mmol) was added to 10 g 4-methyl pyridine (0.11 mmol) followed by 0.5 g of 1-methyl imidazole (0.01 mmol) and the formed mixture was added the stearic anhydride mixture and refluxed for 2 h. Acetic anhydride (4 ml, 0.04 mmol) was added and refluxed overnight and after that acetic acid was distilled off. 62.5 wt %/olignin and 37.5 wt % stearic acid.

The substituted lignin (Lignol®) was soluble in light gas oil (LGO, 10 mg) and in toluene and HMBC measurement shown no presence of free fatty acids. FIGS. 1a and 1b discloses PNMR and shows no free acids at 134 ppm.

TAN Measurement

Titration solution: 0.1 mmol/mL [600 mg KOH in 107 mL EtOH].

Blank 200 mL [Toluene:EtOH 1:1], Tit sol. 1.0 mL to 1.5 mL.

Dissolved 0.61 g 291A in 200 mL [Toluene:EtOH 1:1] and added 3 mg of phenolphthalein.

Titrated to red using 2.25 mL Tit sol-1=1.25 mL.=0.125 mmol KOH=7.01 mg KOH 7.01/0.61=TAN=11.5 [mg KOH/g Lignol®].

### Example 2

Oleic acid (1.67 mg, 0.01 mmol) and acetic anhydride (2.01 ml, 0.02 mmol) was mixed and heated at 120° C. for 3 h. Acetic acid and any excess of acetic anhydride were distilled off (1 h). Lignoboost® lignin (solvent extracted, 5 mg, 0.03 mmol) was added to 5 g 4-methyl pyridine (0.05 mmol) followed by 0.25 g of 1-methyl imidazole and the formed mixture was added to the oleic anhydride mixture and refluxed for 2 h. Acetic anhydride (2 ml, 0.02 mmol) was added and refluxed over night and after that acetic acid was distilled off. 75 wt % lignin and 25 wt % oleic acid.

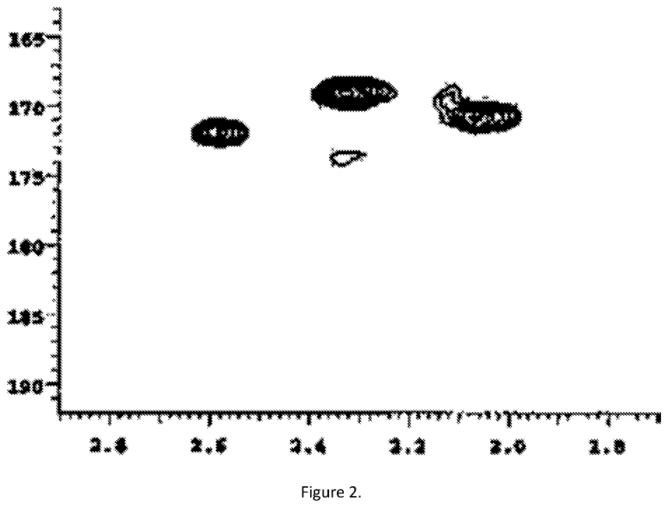

The substituted lignin (Lignol®) was soluble in light gas oil (LGO, 5 mg) and in toluene and HMBC measurement shown no presence of free fatty acids, FIG. 2.

TAN=2.2[mg KOH/g Lignol®].

### Example 3

Oleic acid (5 mg, 0.02 mmol) and acetic anhydride (2.01 ml, 0.02 mmol) was mixed and heated at 120° C. for 3 h. Acetic acid was distilled off (1 h). Lignoboost lignin (extracted, 5 mg, 0.03 mmol) was added to 5 g 4-methyl pyridine (0.05 mmol) followed by 0.25 mg of 1-methyl imidazole and the formed mixture was added the oleic anhydride mixture and refluxed for 2 h. Acetic anhydride (2 ml, 0.02 mmol) was added and refluxed overnight and after that acetic acid was distilled off. 50 wt % lignin and 50 wt % oleic acid.

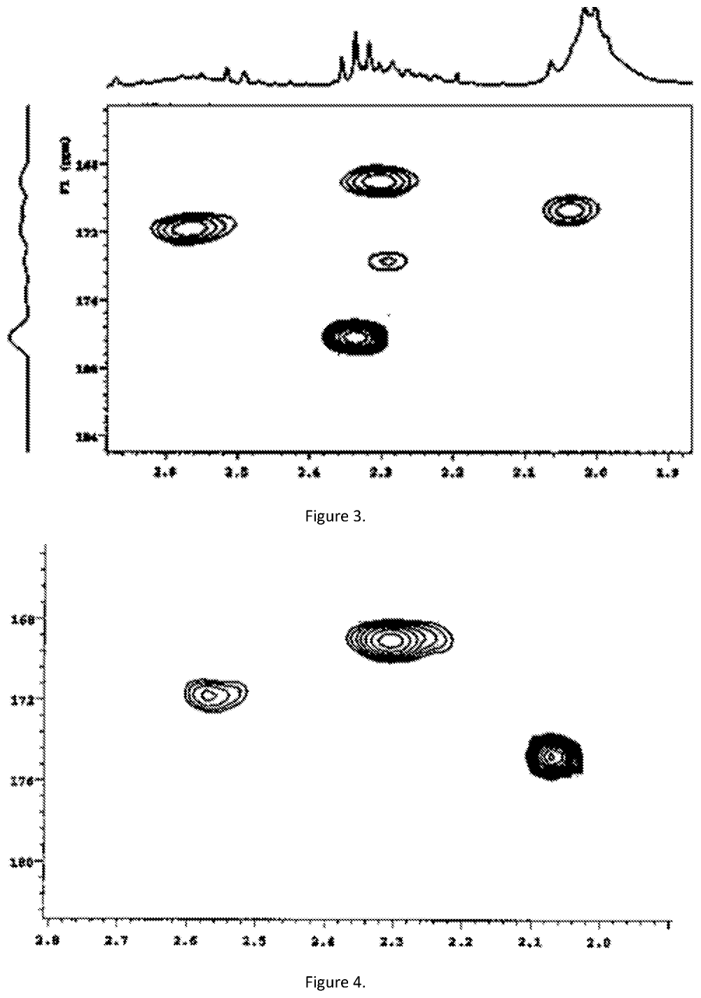

The substituted lignin (Lignol®) was soluble in light gas oil (LGO, 5 mg) and in toluene and HMBC measurement show presence of of free fatty acids, FIG. 3 (fatty acids is seen at 178 ppm).

TAN=53.7[mg KOH/g Lignol®].

### Example 4

This example was done to see if the process could be scaled up.

Oleic acid (60 mg, 0.21 mmol) and acetic anhydride (40 ml, 0.43 mmol) was mixed and refluxed for 3 h. Acetic acid and excess of acetic anhydride was distilled off (0.5 h). Lignoboost lignin (extracted, 100 mg, 0.56 mmol) was added to 100 mg 4-methyl pyridine (1007 mmol) followed by 5 mg (0.06 mmol) of 1-methyl imidazole and the formed mixture was added to the oleic anhydride mixture and refluxed at 190° C. for overnight. Acetic anhydride (2 ml, 0.02 mmol) was added and refluxed overnight and after that acetic acid was distilled off. 62.5 wt % lignin and 37.5 wt % oleic acid.

The substituted lignin (Lignol®) was dissolved in LGO (840 mg) by adding LGO at 130° C. HMBC measurement showed no presence of free fatty acid, FIG. 4.

The carbon content was 84.25%, hydrogen 12.64%, nitrogen 610 ppm, oxygen 2.92% and sulfur 2590 ppm.

### Example 5

Refined tall diesel (RTD) with 15% LGO (4.10 mg, 0.01 mmol) and acetic anhydride (1.94 ml, 0.02 mmol) was mixed and refluxed for 18 h and then distilled for 1 h. Lignoboost lignin (extracted, 4.1 mg, 0.02 mmol) was mixed with 4.1 g 4-methyl pyridine (0.04 mmol) followed by 0.21 g of 1-methyl imidazole and the formed mixture was added the stearic anhydride mixture and refluxed for 2 h. Acetic anhydride (1.94 ml, 0.02 mmol) was added and refluxed for 2 h and after that acetic acid was distilled off.

The substituted lignin (Lignol®) was dissolved in LGO by adding LGO at 150° C.

The sample was analyzed with GPC, and HMBC measurement shown no presence of free fatty acids.

### Example 6

Oleic acid (600 mg, 2.13 mmol) and acetic anhydride (434 ml, 4.25 mmol) was mixed and refluxed for 2 h. Acetic acid and excess of acetic anhydride was distilled off (0.5 h). Lignoboost® lignin (1000 mg, 5.56 mmol) was added to 1000 mg 4-methyl pyridine (10.74 mmol) followed by 50 mg of 1-methyl imidazole and the formed mixture was added to the oleic anhydride mixture and refluxed at 190° C. for 2 h. Acetic anhydride (434 ml, 4.25 mmol) was added and refluxed for 2 h and after that acetic acid was distilled off at reduced pressure. 62.5 wt % lignin and 37.5 wt % oleic acid.

The substituted lignin (Lignol®) was dissolved in LGO (8400 mg) and toluene by adding LGO at 130° C.

### Example 7

In this experiment the acetic anhydride that is removed from the first mixture is reused in the process by adding it to third mixture.

Oleic acid (2000 mg, 7.08 mmol) and acetic anhydride (926 ml, 9.80 mmol) was mixed and heated at 140° C. for 2 h. Acetic acid and excess of acetic anhydride was distilled off (0.5 h). 2069 mg 4-methyl pyridine (22.22 mmol) was added to the oleic anhydride mixture together with 114 mg of 1-methyl imidazole and then was Lignoboost lignin (extracted, 3333 mg, 18.52 mmol) added and the mixture was heated at 190° C. Acetic anhydride (new and reused distillate from the first step) (617 ml, 6.54 mmol) was added and refluxed for 3 h and after that acetic acid and any excess of anhydride was distilled off at reduced pressure. 62.5 wt % lignin and 37.5 wt % oleic acid.

The substituted lignin was dissolved in 3333 mg of LGO and was also soluble in toluene.

### Example 8

Determining of Number of Hydroxyl Groups.

Three stock solutions were prepared according to prior art. 30 mg of lignin (Lignoboost® from Södra) was added to 100 μl to each standard solution and mixed for 120 minutes. 400 μl CDCl3 was used to 100 μl of the sample solution and was analyzed using phosphorus NMR (31PNMR) was run on a Varian 400 MHz (D1=25 seconds, 128 scans).

### Example 9

Solvent extraction of acid precipitated lignin (LB=Lignoboost®). To a total of 3.3 L of solvent [EtOAc/95% EtOH/Pentane 24:6:3] in a bucket was 600 g LB added (the pentane was added separately after LB was dissolved in EtOAc/EtOH) and was left standing overnight and decanted in the morning. The isolated lignin was dried in a rotary evaporator during heating (70-90° C.). Yield: 250 g.

### Example 10

Solvent extraction of acid precipitated lignin (LB=Lignoboost) was done as in Example 9 using

| | | |
|---|---|---|
| LB | 1080 | g |
| EtOAc | 4320 | ml |
| EtOH | 1080 | ml |
| Pentane | 540 | ml |
| Total solvent | 5940 | ml |
| LB out | 450 | g |

EtOAc—ethyl acetate
EtOH—ethanol

### Example 11

The purpose was to study how RTD/AcO-ratio of esters in substituted lignin (Lignol®) is affected by the choice of the catalyst (4-methyl pyridine and N-methyl imidazole) and other parameters. The reusability of catalyst was studied.

Methods, Results & Discussion

Dry and ultrapure lignin (LB from Backhammar) was used as a standard kraft lignin, 5 g in each reaction unless otherwise stated. 70 w % acetic anhydride was used in all reactions.

A typical run, in terms of temperature and pressure is shown in FIG. 7. The distillate was condensed in a cold trap at −78° C. and the amount of recovered catalyst was determined by ¹H NMR (error determined to ±0.1%). A sample of Lignol was taken out for gHMBC for determination of substitution. The rest of material was dissolved in 32.5 g LGO, centrifuged to remove insoluble parts.

The insoluble parts were further washed with LGO, pentane and finally dried to determine the amount of residue.

An oleic acid ester of LB was prepared as a reference (with oleic anhydride and methylimidazole).

The choice between methyl pyridine or methylimidazole as catalysts did not affect the LGO-solubility, however the latter produced a Lignol with somewhat higher RTD/AcO-ratio of esters. Further studies might be needed to show how RTD/AcO-ratio of Lignol would affect the hydrotreatment.

The recovery of the catalyst could be improved with the aid of higher vacuum or the use of LGO or nitrogen as a distillation pusher in the end of the reaction.

1. A composition comprising hydrocarbon oil and substituted lignin, wherein the lignin has been substituted by esterification and acetylation of the hydroxyl groups, wherein the hydroxyl groups are esterified with a C14 or longer fatty acid at a degree of substitution of at least 20%, wherein the hydroxyl groups are acetylated at a degree of substitution of at least 20% and wherein at least 90% of the hydroxyl groups of the lignin is substituted by esterification and acetylation; and
wherein the composition is essentially free from free fatty acid and wherein the TAN of the composition is less than 60 mg KOH/g substituted lignin.

2. The composition according to claim 1 wherein the TAN is less than 50 or less than 40 KOH/g substituted lignin.

3. The composition according to claim 1 wherein the lignin is esterified at a degree of substitution of 25-45% and acetylated at a degree of substitution of 55-75%.

4. The composition according to claim 1 wherein the lignin is esterified at a degree of substitution of 55-75% and acetylated at a degree of substitution of 25-45%.

5. The composition according to claim 1 wherein the at least 95% of the hydroxyl groups of the lignin is substituted.

6. The composition according to claim 1 wherein the concentration of the substituted lignin in the composition is 2 weight % or more.

7. The composition according to claim 1 wherein the composition comprises 20 weight % or more of hydrocarbon oil.

8. The composition according to claim 1 wherein the fatty acid is oleic acid, stearic acid or tall oil fatty acids.

9. The composition according to claim 1 wherein the hydrocarbon oil is gas oil.

10. The composition according to claim 1 wherein the amount of solvent is less than 5 wt %.

11. The composition according to claim 1 wherein the total amount of metals is less than 50 ppm.

12. A method of preparing the composition according to claim 1 wherein the method comprises:
a. Providing lignin, a C14 or longer fatty acid, a solvent, a nitrogen containing aromatic heterocycle catalyst, hydrocarbon oil and acetic anhydride;
b. Mixing the fatty acid with an molar excess of acetic anhydride forming a first mixture;
c. Heating the first mixture forming fatty acid anhydride and acetic acid;
d. Removing the formed acetic acid;
e. Mixing the lignin, the fatty acid anhydride, the solvent and the catalyst forming a second mixture;
f. Heating the second mixture forming esterified lignin and free fatty acid;
g. Adding acetic anhydride to the second mixture comprising esterified lignin and free fatty acid forming a third mixture wherein the amount of acetic anhydride is in molar excess to the free fatty acid;
h. Heating the third mixture forming the substituted lignin and acetic acid;
i. Removing the formed acetic acid and optionally any excess of acetic anhydride;
j. Mixing the substituted lignin with the hydrocarbon oil.

13. The method according to claim 12 wherein the catalyst is 1-methylimidazole or 4-methyl-pyridine or a mixture thereof.

14. The method according to claim 12 wherein the solvent is selected from pyridine, 4-methyl-pyridine or a mixture thereof.

15. The method according to claim 12 wherein the first mixture is heated to at least 120° C.

16. (canceled)

17. The method according to claim 12 wherein the third mixture is refluxed.

18. The method according to claim 12 wherein the solvent and the catalyst is removed prior to or after the addition of the hydrocarbon oil.

19. The method according to claim 12 wherein the amount of fatty acid anhydride is one equivalence or less to the amount of hydroxyl groups on the lignin.

20. The method according to claim 19 wherein the amount of fatty acid anhydride is less than 0.9 equivalence or less than 0.8 equivalence to the amount of hydroxyl groups on the lignin.

21. The method according to claim 12 wherein the provided lignin is solvent extracted lignin.
